(19) United States
(12) Patent Application Publication
(10) Pub. No.: US 2011/0156487 A1
(43) Pub. Date: Jun. 30, 2011

(54) Wireless Energy Transfer with Energy Relays

(76) Inventors: Koon Hoo Teo, Lexington, MA (US); Vishwanath Iyer, Natick, MA (US); William S. Yerazunis, Acton, MA (US); Zafer Sahinoglu, Arlington, MA (US); Da Huang, Durham, NC (US)

(21) Appl. No.: 12/650,221

(22) Filed: Dec. 30, 2009

(51) Int. Cl. H02J 17/00

(52) U.S. Cl. 307/104

(57) ABSTRACT

Embodiments of the invention disclose a method and a system configured to transfer energy wirelessly, comprising a source configured to transfer the energy wirelessly to a sink via a coupling of evanescent waves, wherein the source generates an electromagnetic (EM) near-field in response to receiving the energy; and an energy relay arranged such that to increase the coupling between the source and the sink, wherein the source, the sink, and the energy relay are electromagnetic and non-radiative structures.

### RELATED APPLICATIONS

This application is related to U.S. patent application Ser. No. (MERL-2218) 12/630,498 filed Dec. 3, 2009, entitled “Wireless Energy Transfer with Negative Index Material” filed by Koon Hoo Teo, and U.S. patent application Ser. No. (MERL-2259) 12/xxx,xxx filed Dec. xx, 2009, entitled “Wireless Energy Transfer with Negative Index Material” co-filed herewith by Koon Hoo Teo and incorporated herein by reference.

### FIELD OF THE INVENTION

The present invention relates to transferring energy, and more particularly, to transferring energy wirelessly.

### BACKGROUND OF THE INVENTION

Wireless Energy Transfer

Inductive coupling is used in a number of wireless energy transfer applications such as charging a cordless electronic toothbrush or hybrid vehicle batteries. In coupled inductors, such as transformers, a source, e.g., primary coil, generates energy as an electromagnetic field, and a sink, e.g., a secondary coil, subtends that field such that the energy passing through the sink is optimized, e.g., is as similar as possible to the energy of the source. To optimize the energy, a distance between the source and the sink should be as small as possible, because over greater distances the induction method is highly ineffective.

Resonant Coupling System

In resonant coupling, two resonant electromagnetic objects, i.e., the source and the sink, interact with each other under resonance conditions. The resonant coupling transfers energy from the source to the sink over a mid-range distance, e.g., a fraction of the resonant frequency wavelength.

FIG. 1 shows a conventional resonant coupling system 100 for transferring energy from a resonant source 110 to a resonant sink 120. The general principle of operation of the system 100 is similar to inductive coupling. A driver 140 inputs the energy into the resonant source to form an oscillating electromagnetic field 115. The excited electromagnetic field attenuates at a rate with respect to the excitation signal frequency at driver or self resonant frequency of source and sink for a resonant system. However, if the resonant sink absorbs more energy than is lost during each cycle, then most of the energy is transferred to the sink. Operating the resonant source and the resonant sink at the same resonant frequency ensures that the resonant sink has low impedance at that frequency, and that the energy is optimally absorbed. An example of the resonant coupling system is disclosed in published U.S. Patent Applications 2008/0278264 and 2007/0222542, incorporated herein by reference.

The energy is transferred, over a distance D, between resonant objects, e.g., the resonant source having a size L₁ and the resonant sink having a size L₂. The driver connects a power provider to the source, and the resonant sink is connected to a power consuming device, e.g., a resistive load 150. Energy is supplied by the driver to the resonant source, transferred wirelessly and non-radiatively from the resonant source to the resonant sink, and consumed by the load. The wireless non-radiative energy transfer is performed using the field 115, e.g., the electromagnetic field or an acoustic field of the resonant system. For simplicity of this specification, the field 115 is an electromagnetic field. During the coupling of the resonant objects, evanescent waves 130 are propagated between the resonant source and the resonant sink.

Coupling Enhancement

According to coupled-mode theory, strength of the coupling is represented by a coupling coefficient k. The coupling enhancement is denoted by an increase of an absolute value of the coupling coefficient k. Based on the coupling mode theory, the resonant frequency of the resonant coupling system is partitioned into multiple frequencies. For example, in two objects resonance compiling systems, two resonant frequencies can be observed, named even and odd mode frequencies, due to the coupling effect. The coupling coefficient of two objects resonant system formed by two exactly same resonant structures is calculated by partitioning of the even and odd modes according to

κ=π|fₑᵥₑₙ−f_{odd}| (1)

It is a challenge to enhance the coupling. For example, to optimize the coupling, resonant objects with a high quality factor are selected

Accordingly, it is desired to optimize wireless energy transfer between the source and the sink.

### SUMMARY OF THE INVENTION

This invention is based on a realization that a coupling of evanescent waves between an energy source and an energy sink can be optimized by arranging strategically at least one or more energy relays in a neighborhood of the source and the sink such that some evanescent waves generated by the source are redirected by the energy relay to the sink.

One embodiment of the invention discloses a system configured to transfer energy wirelessly, comprising a source configured to transfer the energy wirelessly to a sink via a coupling of evanescent waves, wherein the source generates an electromagnetic (EM) near-field in response to receiving the energy; and an energy relay arranged such that to increase the coupling between the source and the sink, wherein the source, the sink, and the energy relay are electromagnetic and non-radiative structures.

Another embodiment of the invention discloses a method for transferring energy wirelessly via a coupling of near-fields, comprising steps of providing a source configured to transfer an energy wirelessly to a sink via the coupling of near-fields of the source and the sink, wherein the source and the sink are electromagnetic (EM) and non-radiative structures configured to generate EM near-fields in response to receiving the energy; providing an energy relay configured to increase the coupling between the source and the sink when the sink is arranged in a predetermined location; and transferring the energy wirelessly.

### BRIEF DESCRIPTION OF THE DRAWINGS

FIG. 1 is a block diagram of a conventional resonant coupling system;

FIG. 2A is an example of a system for transferring energy using an energy relay according to embodiments of the invention;

FIG. 2B is a diagram of an electromagnetic structure according an embodiment of the invention;

FIGS. 3-5 are diagrams of different energy distribution pattern;

FIG. 6 is an example of a system for supplying energy wirelessly using multiple energy relays;

FIG. 7 example of an implementation of the energy relay; and

FIGS. 8-13 are schematics illustrating effects of different embodiments of the invention.

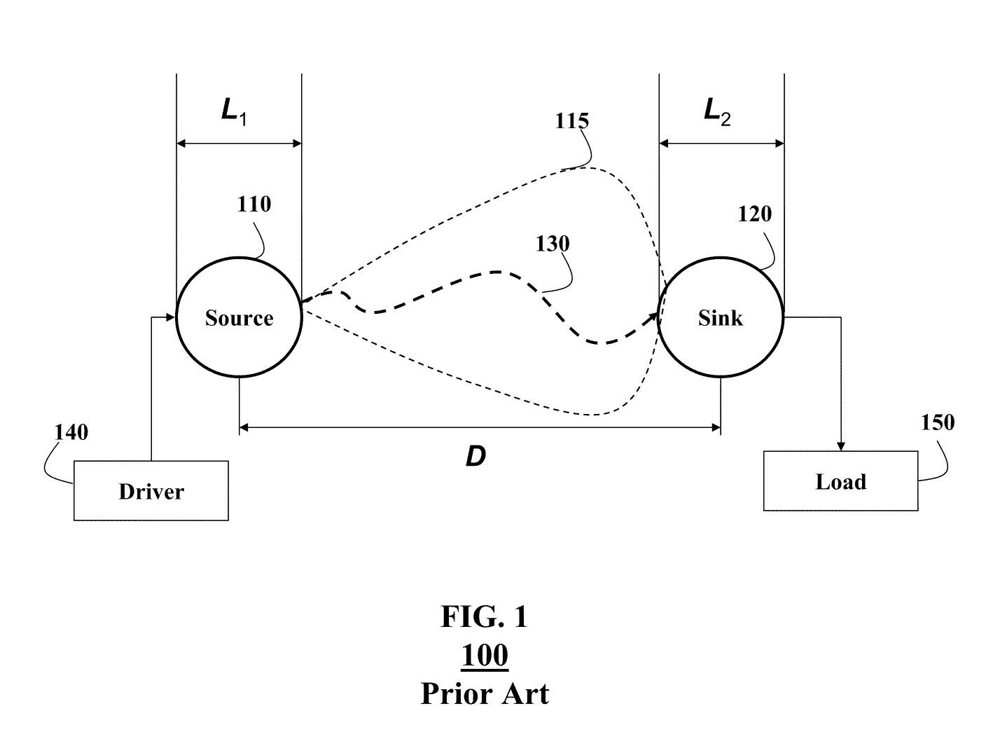

### DETAILED DESCRIPTION OF THE PREFERRED EMBODIMENTS

Embodiments of the invention are based on a realization that a coupling of evanescent waves between an energy source and an energy sink can be optimized by arranging strategically at least one energy relay in a neighborhood of the source and the sink such that some evanescent waves generated by the source are redirected by the energy relay to the sink.

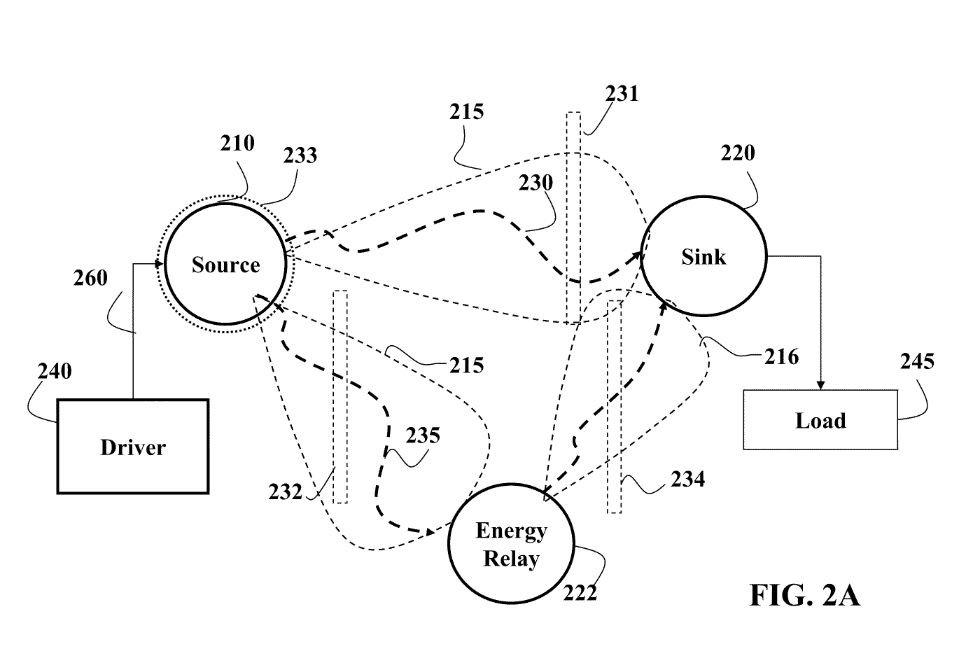

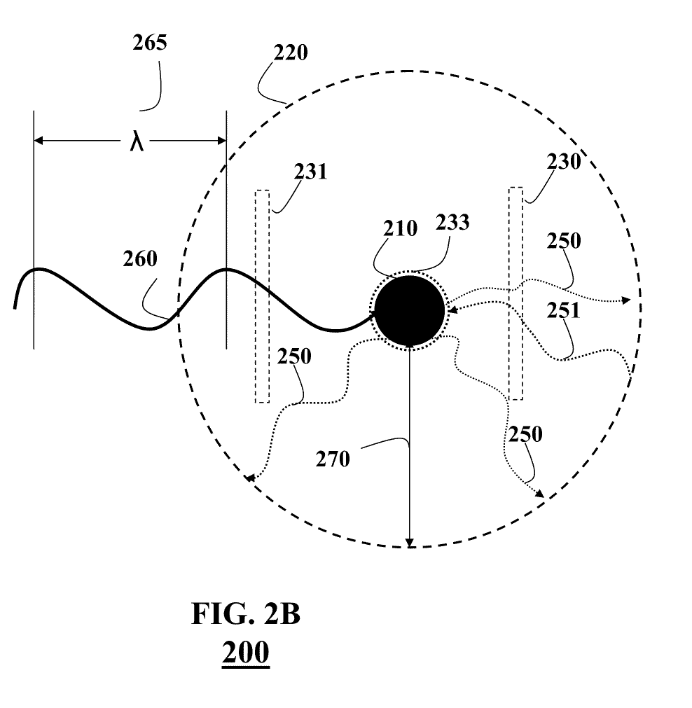

FIG. 2A shows an embodiment of our invention configured to optimized wireless energy transfer from the source 210 to the sink 220. When the driver 240 supplies the energy 260 to the source 210, the source generates an EM near-field 215. Typically, the near-field 215 is generated according to a particular energy distribution pattern. The pattern, as described below, has different zones such as optimal zones, wherein near-field intensities are optimal, i.e., maximum. In blind zones, the near-field intensities are suboptimal.

Some of the evanescent waves 230, which are confined to the near field 215, directly reach and couple to the sink. However, some other evanescent waves 235 reach the energy relay 222 and are redirected to the sink within a near-filed 216. Without the energy relay, the waves 235 are substantially useless for the energy transmission.

A distance and an orientation between the source and the sink are used to determine a particular arrangement of the energy relay. In some embodiments, the energy relay is passive, i.e., the energy not connected to any external source of energy and redirects the evanescent waves received from the source. In other embodiments, the energy relay is active, i.e., configured to absorb some of the energy transferred with the near-field 215, amplify the energy and regenerate the near-filed 216. Accordingly, the embodiments increase the coupling between the source and the sink and facilitate transferring the energy wirelessly between the source and the sink over a longer distance than without the relay.

FIG. 2B shows a structure 200 according an embodiment of the invention. The system is configured to exchange, e.g., transmit or receive, energy wirelessly and includes the structure 210 configured to generate an electromagnetic near-field 220 when the energy is received by the structure and exchange the energy wirelessly via a coupling of evanescent waves.

In one embodiment, the energy 260 is supplied by the driver 240 as known in the art. In this embodiment, the structure 210 serves as a source of the wireless energy transfer system. In an alternative embodiment, the energy 260 is supplied wirelessly from the source (not shown). In that embodiment, the structure 210 serves as the sink of the wireless energy transfer system.

The system 200 optionally includes negative index material (NIM) 231-234 arranged within the near-field 215-216. In one embodiment, the NIM 233 substantially encloses the EM structure 210. The NIM is a material with negative permittivity and negative permeability properties. Several unusual phenomena are known for this material, e.g., evanescent wave amplification, surface plasmoni-like behavior and negative refraction. Embodiments of the invention appreciated and utilized the unusual ability of NIM to amplify evanescent waves, which optimizes wireless energy transfer.

The shape and dimensions of the near-field, i.e., the energy distribution pattern, depends on a frequency of the external energy 260, and on a resonant frequency of the EM structure 210, determined in part by a shape of the EM structure, e.g., circular, helical, cylindrical shape, and parameters of a material of the EM structure such as conductivity, relative permittivity, and relative permeability.

Usually, a range 270 of the near-field is in an order of a dominant wavelength of the system. In non resonant systems, the dominant wavelength is determined by a frequency of the external energy 260, i.e., the wavelength λ 265. In resonant systems, the dominant wavelength is determined by a resonant frequency of the EM structure. In general, the dominant wavelength is determined by the frequency of the wirelessly exchanged energy.

The resonance is characterized by a quality factor (Q-factor), i.e., a dimensionless ratio of stored energy to dissipated energy. Because the objective of the system 200 is to transfer or to receive the energy wirelessly, the frequency of the driver or the resonant frequency is selected to increase the dimensions of the near-field region. In some embodiments, the frequency of the energy 260 and/or the resonant frequency is in diapason from MHz to GHz. In other embodiments, aforementioned frequencies are in the domain for visible light.

Evanescent Wave

An evanescent wave is a near-field standing wave with an intensity that exhibits exponential decay with distance from a boundary at which the wave is formed. The evanescent waves 235 are formed at the boundary between the structure 210 and other “media” with different properties in respect of wave motion, e.g., air. The evanescent waves are formed when the external energy is received by the EM structure and are most intense within one-third of a wavelength of the near field from the surface of the EM structure 210.

Whispering Gallery Mode (WGM)

Whispering gallery mode is the energy distribution pattern in which the evanescent waves are internally reflected or focused by the surface of the EM structure. Due to minimal reflection and radiation losses, the WGM pattern reaches unusually high quality factors, and thus, WGM is useful for wireless energy transfer.

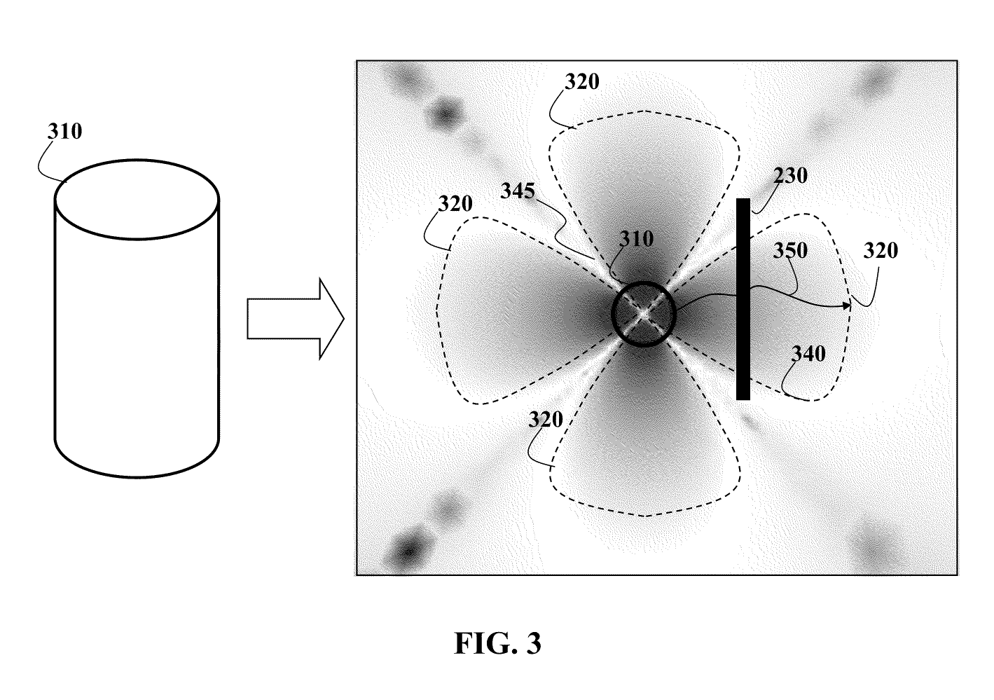

FIG. 3 shows an example of the EM structure, i.e., a disk 310. Depending on material, geometry and dimensions of the disk 310, as well as the dominant frequency, the EM near-field intensities and energy density are maximized at the surface of the disk according to a WGM pattern 320.

The WGM pattern is not necessarily symmetric to the shape of the EM structure. The WGM pattern typically has blind zones 345, in which the intensity of the EM near-field is minimized, and optimal zones 340, in which the intensity of the EM near-field is maximized. Some embodiments of the invention place the NIM 230 in the optimal zones 340 to extend a range of the evanescent waves 350.

Even and Odd Modes

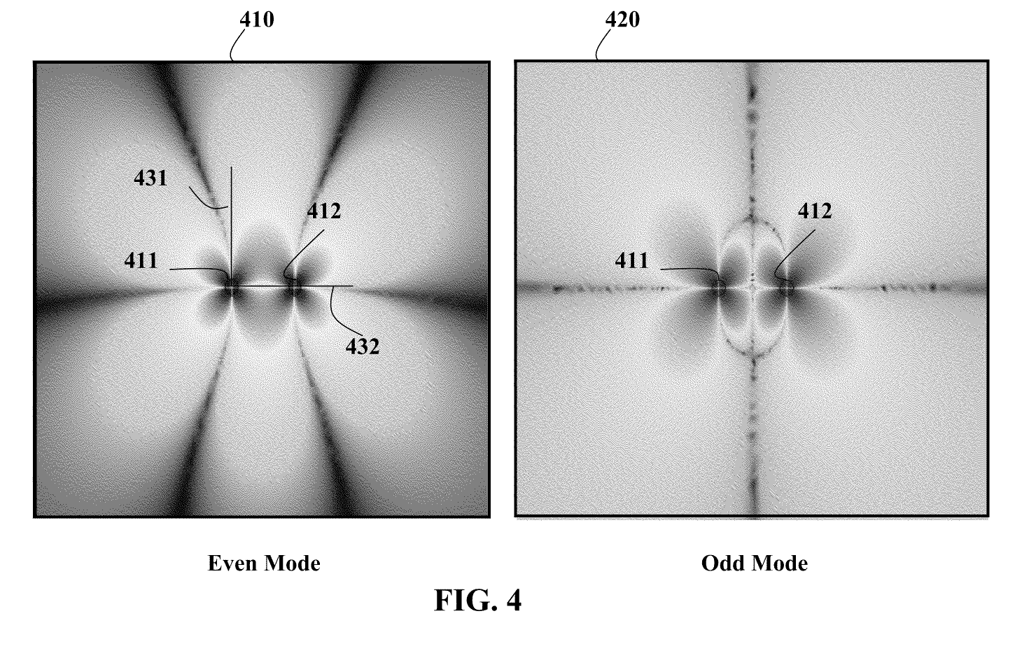

FIG. 4 shows a butterfly energy distribution pattern. When two EM structures 411 and 412 are coupled to each other forming a coupled system, the dominant frequency of the coupled system is represented by even and odd frequencies. The near-field distribution at even and odd frequencies is defined as even mode coupled system 410 and an odd mode coupled system 420. Typical characteristic of the even and the odd modes of the coupled system of two EM structures is that if the EM field is in phase in the even mode then the EM field is out of phase in the odd mode.

Butterfly Pair

The even and odd mode coupled systems generate an odd and even mode distribution patterns of the near-field intensities defined as a butterfly pair. The EM near-field intensity distribution of the butterfly pair reaches minimum in two lines 431 and 432 oriented at 0 degree and 90 degree to the center of each EM structure, i.e., blind zones of the butterfly pair. However, it is often desired to change the intensity distribution and eliminate and/or change the positions and/or orientations of the blind zones.

Crossing Pair

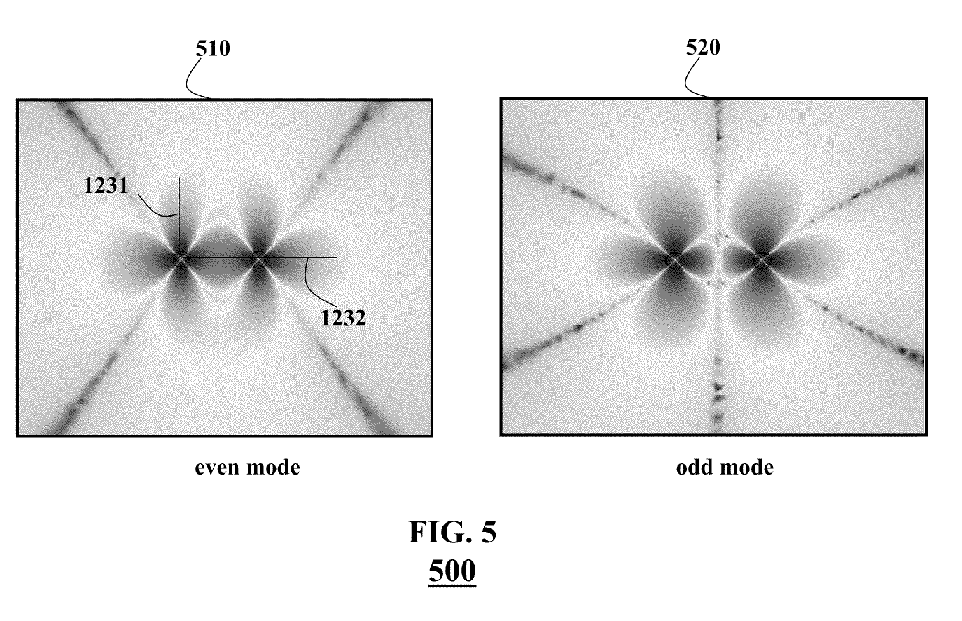

FIG. 5 shows distribution patterns of the near-field intensities according embodiments of the invention define as a crossing pair 500. The crossing pair distribution pattern has optimal zones 531 and 532 oriented at 0 degree and 90 degree to the center of each EM structure, i.e., the optimal zones of the crossing pair pattern corresponds to the blind zones of the butterfly pair pattern. Therefore, one important characteristic of the butterfly pair and the crossing pair patterns is that their respective blind zones are not overlapping, and thus allows for eliminating the blind zones when both kinds of patterns are utilized. Butterfly and crossing patterns have the system quality factor and the coupling coefficient of the same order of magnitude.

Energy Relays Arrangement

Some embodiments of the invention use the knowledge of butterfly and crossing pair energy distribution pattern to arrange the energy relays in the neighborhood of the source and the sink. In some embodiment the location of the sink is predetermined, and the energy relays are arranged such that to optimize the coupling between the source and the sink when the sink is arranged in the predetermined location. In some embodiments this objective is achieved experimentally.

In another embodiment, the source is configured to transmit the energy to multiple sinks. Accordingly, the energy relays are arranged to increase the coupling of more than one sink.

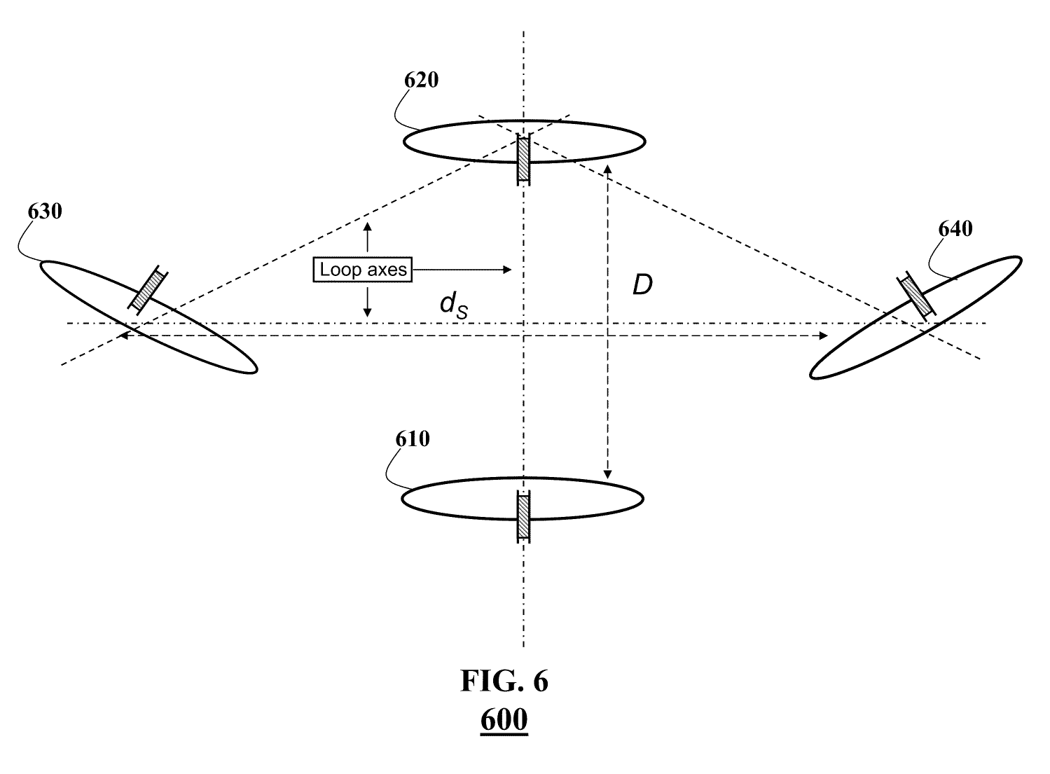

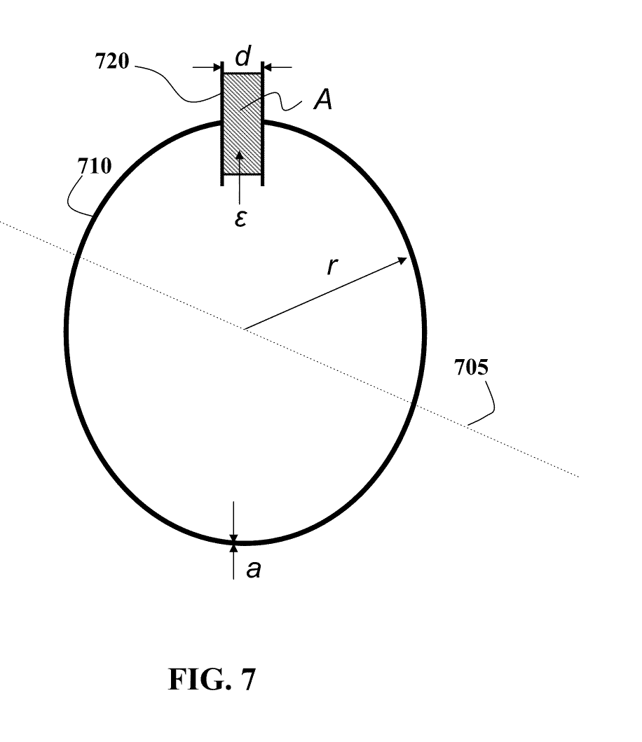

FIG. 6 shows an example of a system 600 configured to optimized transmission of the energy from the source 610 to the sink 620 using a first energy relay 630 and a second energy relay 640. In this embodiment, the EM structures of the source, sink, and the energy relay are implemented as a loop 700 as shown in FIG. 7. The loop of a radius r is formed by a conductor wire 710 of a radius a, and by a capacitor 720 having a relative permittivity a A plate area of the capacitor is A, and the plates are separated over a distance d. The loop 700 has axis 705 and is a resonant structure. However, other embodiment uses different implementation of the structures, e.g., a disc.

The source 610 and the sink 620 are arranged over a distance D from each other measured from their respective centers. The source and the sink are aligned such that axes of the source and the sink lie along the same line. The source is connected to the driver (not shown) and the sink is connected to the load (not shown).

The first and the second energy relays are separated by a distance d_{S} and are arranged such as to increase the coupling of evanescent waves between the source and the sink. The distance d_{S} is selected such that the energy relays are not coupled strongly to each other. In one embodiment, the loops of the energy relays are rotated such that their axes points towards the sink. In another embodiment the axes of the loops of the energy relays are perpendicular to the axis of the source and sink. In yet another embodiment the orientation of the energy relays is arbitrary.

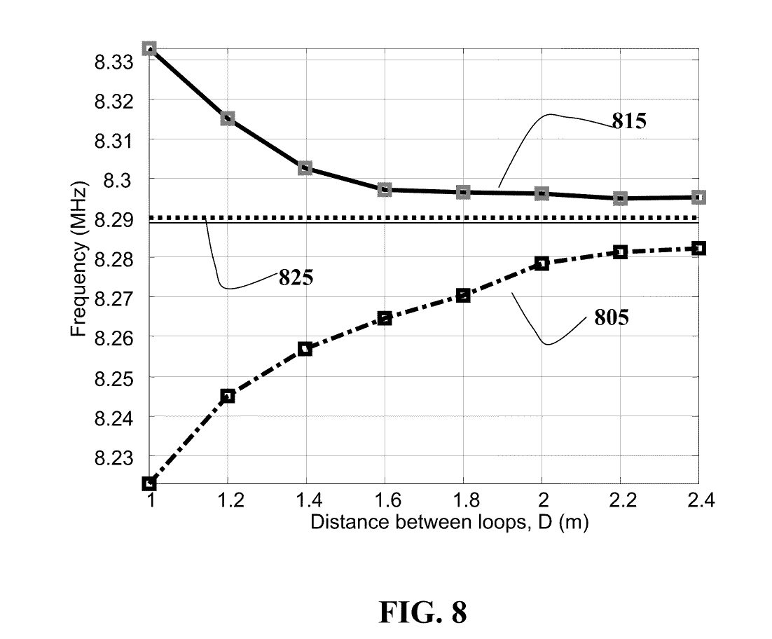

FIGS. 8-11 show schematics illustrating dependencies of frequencies of the system on arrangements of the source 610 and the sink 620, wherein the energy relays are inactive. For example, as the distance between the source and the sink increases the odd 805 and even 815 mode frequencies converge towards a dominant frequency 825, as shown in FIG. 8.

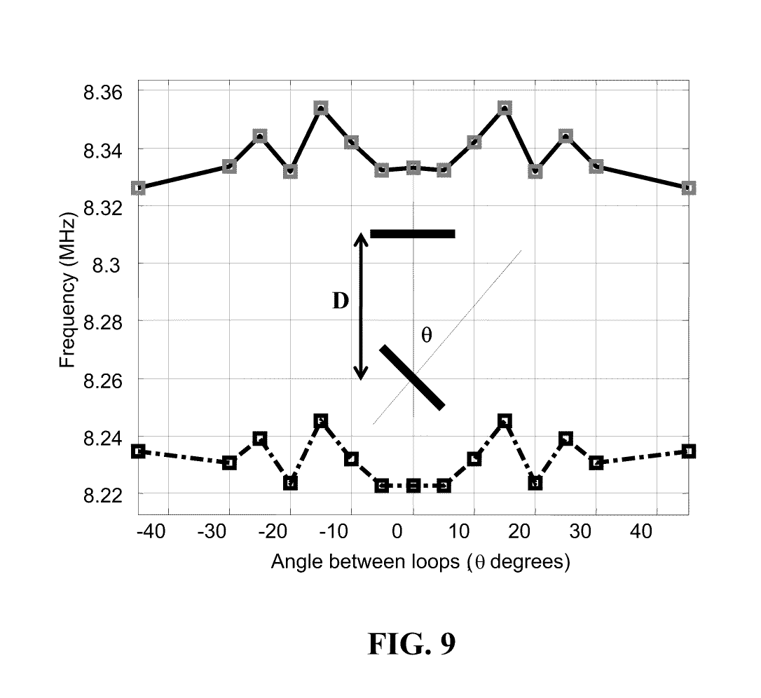

FIG. 9 shows a schematic illustrating effect of the rotation of either the source or the sink on the mode frequencies. In this embodiment, the two mode frequencies relatively stable despite of the rotation.

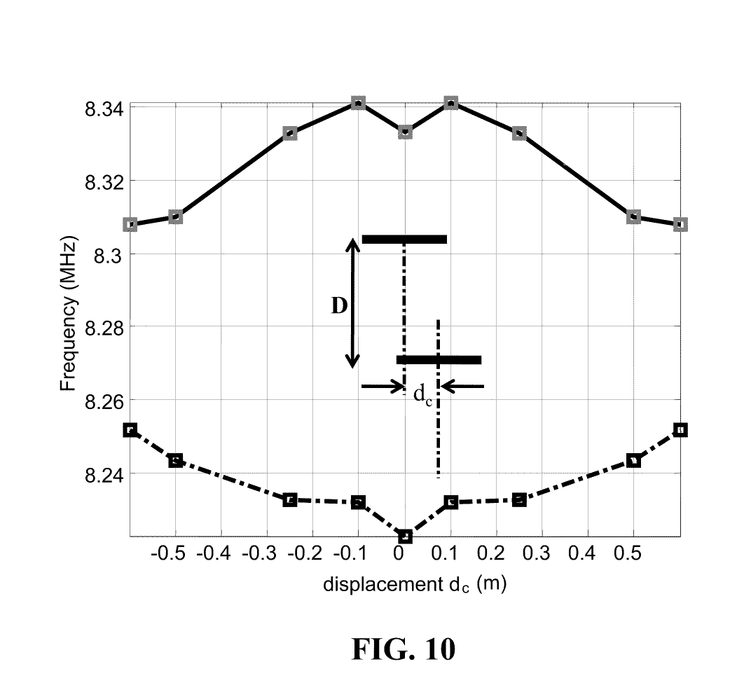

FIG. 10 shows a schematic illustrating effect of displacement of the source or the sink from the coaxial alignment on the mode frequencies. In one embodiment, the displacement is within a range from 60 cm to 0. As shown, after the displacement reaches a threshold, e.g., 60 cm, the odd and even frequencies approach the individual resonator frequencies.

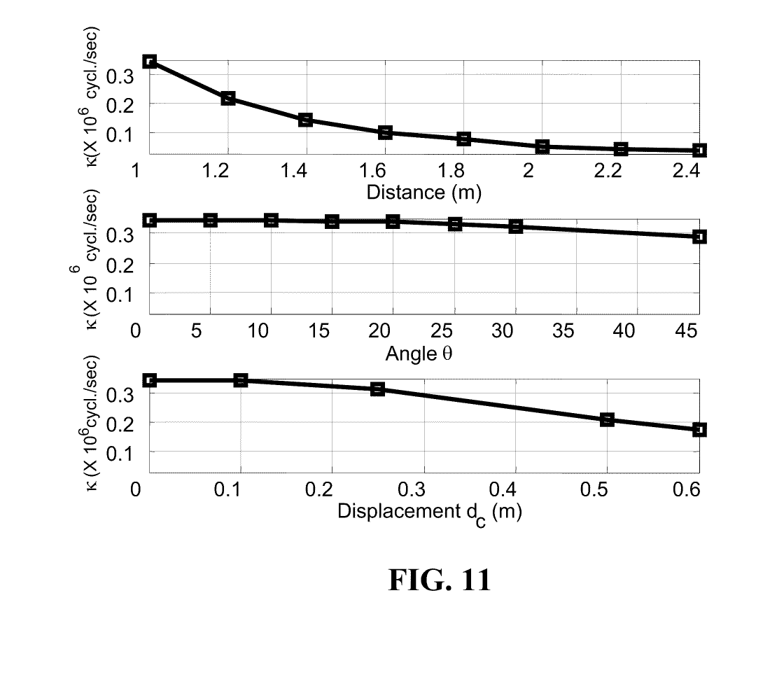

FIG. 11 shows coupling coefficients for different arrangements of the source and the sink. As shown, the distance between the source and the sink affect the coupling coefficient the most, followed by the displacement and then the rotation.

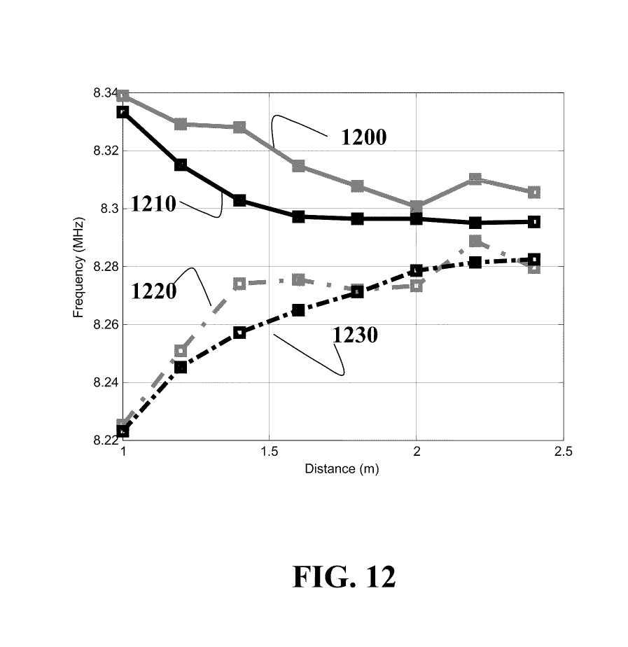

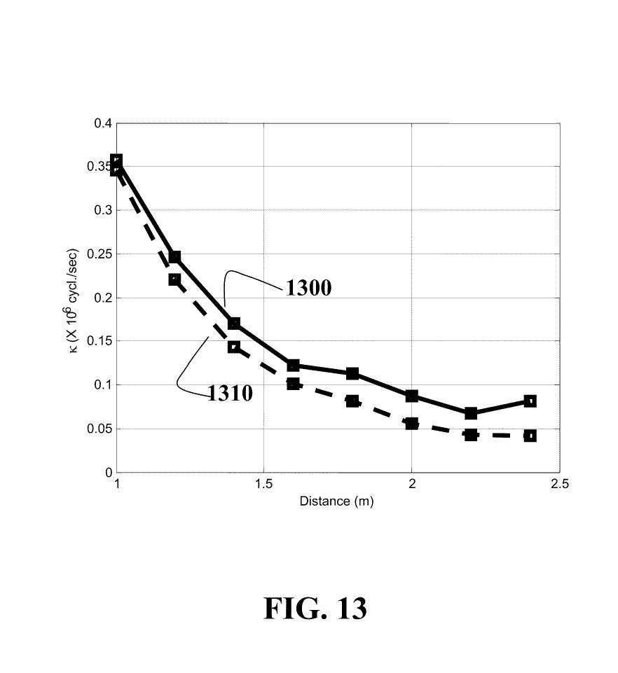

FIGS. 12 and 13 show graphs comparing embodiments of the invention with and without energy relays. FIG. 12 shows that the coupling coefficient is larger for the system which includes the energy relays, i.e., the curves 1200 and 1220, than for the system with the inactive energy relays, i.e., the curves 1210 and 1230. FIG. 13 shows the comparison between the coupling coefficients of the systems with and without energy relays.

Some embodiments of the invention use a larger network of passive or active energy relays that allow the coupling to be optimized over a range of distances. Typically, the energy relays are arranged such that they do not strongly couple to the sink-source resonant link.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A system configured to transfer energy wirelessly, comprising:
a source configured to transfer the energy wirelessly to a sink via a coupling of evanescent waves, wherein the source generates an electromagnetic (EM) near-field in response to receiving the energy; and
an energy relay arranged such that to increase the coupling between the source and the sink, wherein the source, the sink, and the energy relay are electromagnetic and non-radiative structures.

2. The system of claim 1, wherein a location of the sink during the energy transfer is predetermined, and wherein the energy relay is arranged such that to increase the coupling of between the source and the sink while the sink is arranged in the predetermined location.

3. The system of claim 1, further comprising:
a driver configured to supply the energy to the source.

4. The system of claim 1, further comprising:
a negative index material (NIM) arranged within the EM near-field such that the coupling is enhanced.

5. The system of claim 1, wherein the source and the energy relay are resonant structures.

6. The system of claim 2, wherein the NIM is arranged based on the predetermined location of the sink.

7. The system of claim 1, wherein the NIM is arranged such as to enclose the source.

8. The system of claim 1, wherein the energy relay is arranged based on an energy distribution pattern selected from a group of patterns consistent of an even butterfly pattern, an odd butterfly pattern, even crossing pattern, and an odd crossing pattern.

9. The system of claim 1, wherein the energy distribution pattern is determined based on a distance and/or an orientation among the source, the energy relay and the sink.

10. The system of claim 1, wherein the NIM has a negative permittivity property and a negative permeability property.

11. The system of claim 1, wherein the energy relay is configured to receive the evanescent waves from the source and redirect at least some of the evanescent waves to the sink.

12. The system of claim 1, wherein the energy relay is configured to receive the energy the source, amplify the energy and transmit the energy to the sink.

13. The system of claim 1, wherein the energy relay includes a loop, wherein the loop is rotated such that an axis of the loop is directed toward the sink.

14. The system of claim 1, wherein the energy relay includes a loop, wherein the loop is rotated such that an axis of the loop is perpendicular to an axis of the sink.

16. The system of claim 1, wherein the energy relay is a first energy relay, further including:
a second energy relay arranged such that to increase the coupling between the source and the sink, wherein the first energy relay is not strongly coupled to the second energy relay.

17. The system of claim 1, further comprising:
a network of passive and active energy relays.

18. A method for transferring energy wirelessly via a coupling of near-fields, comprising steps of:
providing a source configured to transfer an energy wirelessly to a sink via the coupling of near-fields of the source and the sink, wherein the source and the sink are electromagnetic (EM) and non-radiative structures configured to generate EM near-fields in response to receiving the energy;
providing an energy relay configured to increase the coupling between the source and the sink when the sink is arranged in a predetermined location; and
transferring the energy wirelessly.

19. The method of claim 18, further comprising:
receiving, by the energy relay, at least part of the energy from the source; and
transferring, by the energy relay, at least part of the energy to the sink.

20. The method of claim 18, further comprising:
increasing the coupling using negative index material (NIM).
